(19) United States
(12) Patent Application Publication
(10) Pub. No.: US 2008/0253405 A1
(43) Pub. Date: Oct. 16, 2008

(54) Method and System for Providing Error Resiliency

(76) Inventors: Patrick Ng, Markham (CA); Paul Chow, Richmond Hill (CA)

Correspondence Address: VOLPE AND KOENIG, P.C.;DEPT. AMD, UNITED PLAZA, SUITE 1600, 30 SOUTH 17TH STREET, PHILADELPHIA, PA, 19103, US

(21) Appl. No.: 11/735,085

(22) Filed: Apr. 13, 2007

(51) Int. Cl. H04J 3/07

(52) U.S. Cl. 370/506

(57) ABSTRACT

A method and system for providing error resiliency in processing a multimedia bitstream. The bitstream includes a start code pattern and the method and system detect the start code pattern and track its location to prevent the bitstream processor from overrunning the start code pattern of a subsequent block of multimedia data and corrupting the subsequent block of data. A shift length limiter receives a location of the start code pattern and the location of a current bit pointer. The shift length limiter calculates the number of bits between the start code pattern location and the current bit pointer location. When the shift length limiter receives a bit shift request, the shift length limiter prevents shifting if the number of bits in the bit shift request exceeds the calculated number of bits between the start code pattern location and the current bit pointer location.

### BACKGROUND

This invention relates generally to digital bitstream processing. Particularly, the present invention relates to detecting data corruption errors in a digital bitstream before these errors can affect the uncorrupted data. The present invention further relates to multimedia bitstream processing, including but not limited to processing of video, audio and still image formats.

Digital video signals are widely used in cable and satellite television, internet communications, digital device communications and various client-server computer applications. Digital video signals are typically encoded using various encoding standards. These standards have been developed to facilitate the transmission and storage of the digital data. For example, well-known video encoding standards include MPEG-1, MPEG-2, MPEG-4, H.261, H.262, H.263, H.264, VC-1, VP7, RealVideo, WMV, Indeo, MJPEG, DivX, Theora and Dirac.

The aforementioned standards provide a syntax for encoding the original video information into a digital bitstream which can be a compressed digital representation of the original video. For example, video signal encoding standards, such as H.261, H.263, MPEG-1, MPEG-2, and MPEG-4, encode the video in a hierarchical manner, in which video frames and fields are grouped together in blocks. The information transmitted for each frame can include the picture start code (SC), picture header, group of block or slice headers, macroblock information, and texture information for each coded block. The SC is a predefined sequence of bits that is usually transmitted before each frame.

Unfortunately, these encoded bitstreams can also be sensitive to bit errors. For example, during a bitstream transmission, a receiving device can detect a first start code that indicates a beginning of a block of data having N number of bits. In actuality, due to an error in the transmission, the number of bits in the bitstream is reduced to N-X, where X is the number of bits lost during the transmission. If the receiving device attempts to process N number of bits, it may overrun the subsequent SC and, possibly, corrupt the next block of data. If the SC overrun does occur, the prior art devices have no choice but to wait for the arrival of the next SC to synchronize the data transmission and start processing of the next frame. As a result, the prior art devices that lose the data received before the expected start code location can cause the corruption and loss of subsequent data received after the expected SC location.

Accordingly, there is a need for a robust bitstream receiving device, capable of preventing SC overruns, thereby minimizing content losses.

### SUMMARY

In accordance with implementations of the invention, one or more of the following capabilities may be provided. The present invention provides a method and apparatus for monitoring a digital bitstream (such as multimedia bitstream carrying audio, video or other multimedia content) and providing error resiliency using start code patterns. The present invention can inhibit the input of blocks of data from the bitstream to the decoder if it is determined that the block of data to be input to the decoder will overrun the start code pattern.

In accordance with the invention, the bitstream can be continuously monitored for occurrences of start code patterns before the bitstream is decoded by a receiver. If a start code pattern is detected and decoder is attempting to process a block of data that would cause the start code pattern to be overrun, the decoder can be notified of an error in the bitstream and inhibited from processing the data beyond the start code pattern. These and other capabilities of the invention, along with the invention itself, will be more fully understood after a review of the following figures, detailed description, and claims.

The present invention can provide error resiliency by identifying the location of a start code pattern in a bitstream by, for example, using a start code monitoring or detecting element. Prior to input to the receiver, the bitstream can be buffered in an input bitstream buffer and fed into a shift register. The shift register can feed a predefined number of bits to the receiver based on the number of bits requested by the receiver. The shift register can be replenished by data from the input bitstream buffer to satisfy subsequent requests from the receiver. A current bit pointer can be used to mark the next location in the bitstream to be input to the receiver. An apparatus or device according to the present invention can use the current bit pointer information and information about the detected start code pattern to anticipate and avoid a start code overrun error. The apparatus or device according to the present invention can determine the number of bits between the start code pattern location and the current bit pointer location to determine the maximum number of bits that can be shifted (and output to the receiver) without overrunning the start code. If the receiver requests a number of bits that exceeds that number of bits between the current bit pointer and the start code pattern location, the present invention can inhibit the shift register from outputting data to the receiver and notify the receiver that an error had occurred. In one embodiment of the present invention, the apparatus or device can raise a hardware or software interrupt if the number of bits requested exceeds the number of bits between the start code pattern location and the current bit pointer location.

A system according to the present invention can be implemented using an input bitstream buffer adapted for storing a portion of the incoming bitstream, an output buffer adapted for storing a portion of the outgoing bitstream, a start code monitor for detecting a start code location in the incoming portion of the digital bitstream in the input buffer, and a shift length limiter for receiving a current bit pointer location from the output bitstream buffer and for calculating a number of bits between the current bit pointer location and the start code location. The output buffer can include a shift register for outputting a predetermined number of bits to the receiver in response to a request from a receiver. The receiver can be or can include a decoder.

A method according to the present invention can include: providing a buffer for buffering a portion of the incoming bitstream destined for a receiver; monitoring the buffered portion of the incoming bitstream for a start code pattern; determining the number of bits between the start code pattern and the next bit to be output to the receiver; receiving a request for a predefined number of bits from the receiver; comparing the number of bits requested by the receiver with the number of bits between the start code pattern and the next bit to be output to the receiver; inhibiting the output of the requested number of bits if the number of bits requested by the receiver is greater than the number of bits between the start code pattern and the next bit to be output to the receiver; indicating an error to the receiver if the number of bits requested by the receiver is greater than the number of bits between the start code pattern and the next bit to be output to the receiver; and outputting to the receiver only the bits between the start code pattern and the next bit to be output to the receiver.

### BRIEF DESCRIPTION OF THE FIGURES

FIG. 1 is a block diagram illustrating a system including the digital bitstream shifter according to the present invention.

FIG. 2 is a block diagram illustrating the components that can be used in the digital bitstream shifter according to the present invention.

FIG. 3 is a flowchart diagram illustrating one example of the shift length limiter logic that can be used in the digital bitstream shifter according to the present invention.

FIG. 4 is a flowchart diagram illustrating one example of the input stream buffer logic that can be used in the digital bitstream shifter according to the present invention.

FIG. 5 is a flowchart diagram illustrating one example of the output bitstream buffer logic that can be used in the digital bitstream shifter according to the present invention.

FIG. 6 is a flowchart diagram illustrating one example of the start code monitor logic that can be used in the digital bitstream shifter according to the present invention.

FIG. 7 is a flowchart diagram illustrating one example of the digital bitstream shifter logic according to the present invention.

### DETAILED DESCRIPTION OF PREFERRED EMBODIMENTS

The present invention is directed to methods and apparatus for identifying errors encountered during digital bitstream processing and preventing them from propagating and corrupting adjacent blocks of otherwise uncorrupted data. These embodiments are illustrative and exemplary, however, and not limiting of the invention as other implementations in accordance with the disclosure are possible.

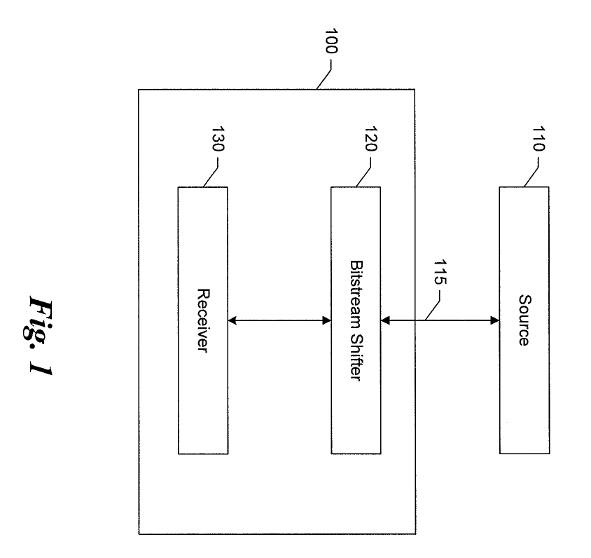

FIG. 1 illustrates an apparatus or system 100 according to the invention. The system 100 can include a bitstream shifter 120, and a receiver 130. System 100 can be connected to a video source 110 via a transmission medium 115. FIG. 1 illustrates the receiver 130 that receives a signal processed by the bitstream shifter 120 and sent from the video source 110. The receiver 130 can be or include a component that processes the bitstream, such as a digital signal processor, a video signal processor or a video decoder.

The video source 110 can be or include any device capable of transmitting or broadcasting a video signal or a bitstream which carries video information. Such devices can include a video broadcasting system, a DVD player, a computer, and a video signal processor. The video source 110 can retrieve digital video data from various storage media, such as CDs, DVDs, tapes and hard drives. For purposes of illustration, source 110 is presented as a source of video content, however, source 110 can be a source of multimedia content (including, for example, audio, video and still images) as well. In alternative embodiments, the source 110 can be the source of any multimedia content that can be represented in a bitstream. The bitstream can include one or more SCs. The SC can be used to indicate the beginning of a grouping (a block, field or frame) of data within the bitstream.

The transmission medium 115 can be any medium adapted for transferring the video signal or video bitstream from a source to a receiver. The transmission medium 115 can be a cable (e.g., coaxial, single or multi-conductor type). Alternatively, the transmission medium 115 can be a network that includes wired and wireless hardware systems and devices for transferring the video signal or video bitstream from the source to the receiver. The transmission medium 115 can include a private or a public network (or both), a cable or satellite communication network, a LAN, a WAN or the Internet. The transmission medium 115 can be implemented using a plurality of servers, routers and switches that route signals or digital data from one device to another. The transmission medium 115 can be implemented using a variety of transport layers, such as TCP, UDP, RTP, SCTP, SPX, ATP and IL. It can also use a variety of network layers, such as IP, ICMP, IGMP, IPX, BGP, OSPF, RIP, IGRP, EIGRP, ARP, RARP and X.25. The data link in the transmission medium 115 can be implemented using Ethernet, Token ring, HDLC, Frame relay, ISDN, ATM, IEEE 802.11, WiFi, FDDI and PPP methods of encoding and transmission of data over network communications media.

The transmission medium 1115 can enable multiple electronic devices to communicate with each another. For example, a server installed in Germany can use the transmission medium 115 to transmit video information to a personal computer located in Japan. Similarly, the transmission medium 115 can be used to transmit the video information between two computers located in a same room.

The bitstream shifter 120 can monitor the bitstream and prevent any bitstream receiving devices from overrunning the start code in order to avoid further errors. The bitstream shifter 120 can be used with a personal computer, digital television receiver, cell phone, pager or a personal digital assistant (e.g. a Blackberry) to monitor the received data and identify errors, before the errors in the bitstream result in errors in processing or mis-interpretation of the data by the receiver 130.

The bitstream shifter 120 can be implemented in discrete components, as a single chip integrated circuit, as a digital signal processor or using a microprocessor and software. The bitstream shifter 120 can be implemented as a separate device, system or component or integrated with the receiver 130. The bitstream shifter 120 comprises at least one buffer for storing a portion of the received bitstream, at least one interface for exchanging information with other devices and, in some embodiments, a processor for processing the data stored in one or more buffers.

The receiver 130 can be a device or system capable of receiving the bitstream from the video source 110 and can include one or more components for processing the data in the bitstream. The receiver 130 can be a personal computer, digital television receiver, cell phone, pager, PDA (e.g. a blackberry), handheld computer, or a component thereof. The receiver 130 can be any device capable of receiving, decoding and/or interpreting digital video information. In some embodiments, the interpreted digital video information can be delivered to a user in the form of a picture, video or a sound.

In accordance with one embodiment of the present invention, the video bitstream can be communicated from a video source 110 over the transmission medium 115 to the receiver 130. Before the communicated video bitstream is received by the receiver 130, the video bitstream is processed, in accordance with the invention, by the bitstream shifter 120. The bitstream shifter 120 can prevent start code overrun errors.

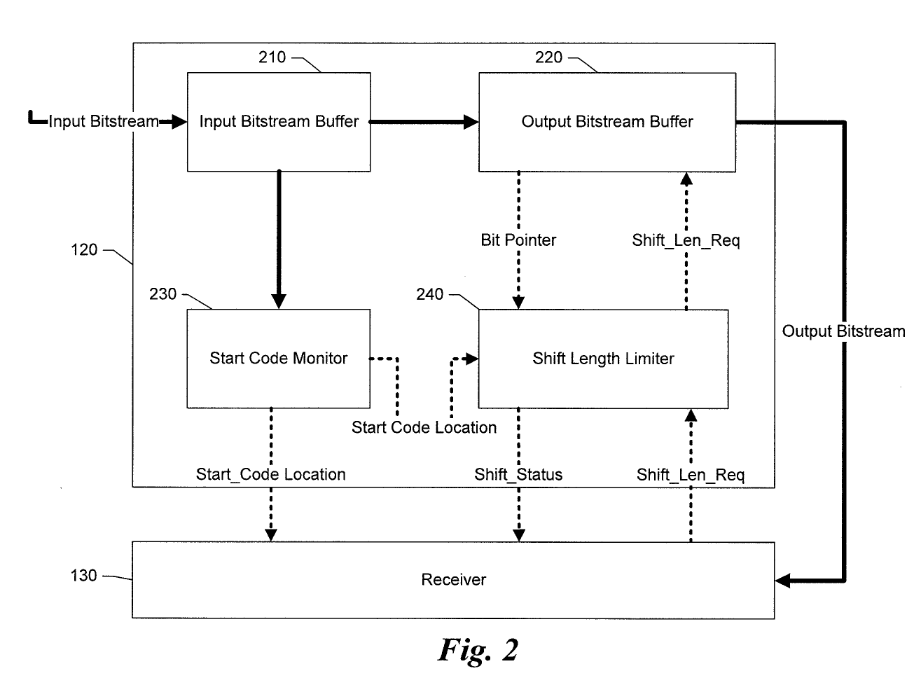

FIG. 2 illustrates one embodiment of the bitstream shifter 120. The bitstream shifter 120 can include an input bitstream buffer 210, a start code monitor 230, a shift length limiter 240, and an output bitstream buffer 220. The bitstream shifter 120 can be in communication with the receiver 130 to receive bitstream data and other information from the bitstream shifter 120.

The bitstream shifter 120 can buffer and process the digital data (such as digital video) in the bitstream transmitted from the sending device 110 to the receiver 130. When the bitstream is received by the bitstream shifter 120, it can be buffered in the input bitstream buffer 210. From the input bitstream buffer 210, the data can be transmitted to the output bitstream buffer 220. From the output bitstream buffer 220 the data can be transmitted to the receiver 130. While the data resides in the input stream buffer 210, the data can be analyzed by the start code monitor 230 to identify start code patterns in the bitstream. When the start code monitor 230 identifies a start code pattern in the received bitstream data, the start code monitor 230 can provide a notification to the shift length limiter 240, indicating the location of the start code. Shift length limiter 240 can prevent start code overruns to occur using the location of the start code that can be received from the start code monitor 230 and the location of the current bit pointer that can be received from the output bitstream buffer 220.

The input bitstream buffer 210 and the output bitstream buffer 220 can be buffer storage devices that can hold a limited amount of data. These storage devices can be implemented using random access memory (RAM) storage. They can also be implemented using flash memory and/or disk drives. The input bitstream buffer 210 and the output bitstream buffer 220 can be implemented in a chip embedded within a device or in a separate module. Generally, bitstream buffers can be used for many purposes, such as interconnecting two digital circuits operating at different rates, holding data for use at a later time, allowing timing corrections to be made on the bitstream, collecting data bits from the bitstream into groups that can then be operated on as a unit, delaying the transfer time of a signal in order to allow other operations to occur.

In some embodiments, according to the present invention, the input bitstream buffer 210 and the output bitstream buffers 220 can provide a set of hardware and/or software interfaces allowing other devices to access and manipulate data stored in these buffers. For example, the input bitstream buffer 210 can provide an interface that allows other devices to control when and how much of the received data stored in the input bitstream buffer is shifted and output to the output buffer 220 at a time. Similarly, the output bitstream buffer 220 can provide interfaces that let other devices control when and how much of the data stored in the output bitstream buffer is shifted and output to the receiver 130 at a time.

The input bitstream buffer 210 can provide an interface for retrieval of a particular bit from a particular memory location stored in the input bitstream buffer 210. This interface can be used to search for start code patterns by retrieving one or more bits and comparing them to known start code patterns. When a predetermined number of bits matches a known start code pattern, a start code can be deemed to be detected and the address or starting location of the start code pattern can be identified and stored in memory. This interface can be used, for example, for retrieving the address of the start code pattern of bits stored in the input bitstream buffer or the position in the bitstream of the start code pattern.

The output bitstream buffer 220 can provide an interface that allows external devices to read the current bit pointer. The current bit pointer can provide an indication of the position of a bit in a portion of the bitstream. Using the current bit pointer, other devices can calculate the number of bits stored in the output bitstream buffer 220. Based on this number of bits, other devices can control the state of the output bitstream buffer 220.

In accordance with one embodiment of the invention, the output bitstream buffer 220 can have 2 states: fill and shift. In the fill state, the output bitstream buffer can receive bits from the input bitstream buffer 210. In the shift state, the output bitstream buffer 220 can shift the bits out of the buffer to the receiver 130. In one embodiment, according to the present invention, the output bitstream buffer 220 can switch between the shift and the fill states automatically. For example, if the number of bits stored in the output bitstream buffer falls below a predefined threshold or is less than the number bits requested by the receiver 130, the output bitstream buffer can switch into fill mode. In fill mode, the output bitstream buffer 220 can load bits. The number of bits loaded can be calculated for each fill cycle (for example, as a function of the threshold or the number of bits requested by the receiver), predetermined to be a set amount or to the maximum capacity of the output bitstream buffer 220.

The start code monitor 230 is a component that analyzes the bitstream data to identify start code patterns. The start code monitor 230 can be a logical or physical device or system which can access the data stored in the input bitstream buffer 210. The start code monitor 230 can be implemented as a software function or a hardware device. It can be implemented in a dedicated chip, a set of discrete components or it can be implemented as a software process controlling the operations of a computer device. For example, such software process could access the data stored in the input bitstream buffer 210 by issuing read memory instructions and reading from the memory allocated for the input bitstream buffer 210.

The start code monitor 230 can also access the data stored in the input bitstream buffer 210 using a set of interfaces provided by the input bitstream buffer 210 to access data stored. In that embodiment, the start code monitor 230 can issue a command to the input bitstream buffer 210, instructing the input bitstream buffer 210 to return at least a portion of the contents of the input bitstream buffer 210 to the start code monitor 230. Alternatively, the start code monitor 230 can process the data being sent out of the input bitstream buffer 210 to determine the location of a start code pattern of bits in the bitstream.

The start code monitor 230 can monitor the bits stored in the input bitstream buffer 210 or sent to the output bitstream buffer 220 and identify the presence and location of one or more start code patterns. Many different start code patterns can be located in the bitstream. The start code monitor 230 can also be responsible for other functions, such as interacting with the shift length limiter 240 and with the receiver 130. When the start code monitor 230 finds the start code the start code monitor 230 can send the location of the start code to other devices.

The shift length limiter 240 can be physical or logical device or system that can limit the number of bits that can be shifted out of the output bitstream buffer 220. The shift length limiter 240 can access the data stored in the output bitstream buffer 220 by reading the memory allocated for the output bitstream buffer 220. In some embodiments, the shift length limiter 240 can also access the data stored in the output bitstream buffer 220 using a set of interfaces provided by the bitstream buffer 220.

The shift length limiter 240 can also instruct the output bitstream buffer 220 to shift a certain number of bits. In one embodiment of the present invention, the shift length limiter 240 can control the shifting mechanism of the output bitstream buffer 220. In other embodiments, the shifting mechanism of the output bitstream buffer 220 can be controlled directly by the receiver 130.

The shift length limiter 240 can also provide an interface that can be used by other devices for sending instructions to the shift length limiter 240. For example, the receiver 130 can send an instruction to the shift length limiter 240, instructing the shift length limiter 240 to shift a number of bits from the output bitstream buffer 220. The shift length limiter 240 can decide, whether the output bitstream buffer 220 can shift this number of bits or not. In one embodiment, the result of the shifting decision can be returned to the requesting device using a Shift_Status flag. In some embodiments the Shift_Status flag value of FALSE can indicated an error (an anticipated start code overrun), while the Shift_Status value of TRUE can indicated success (the number of bits requested can be shifted without overrun error).

In accordance with the method of the invention, the input bitstream can be received and shifted by the input bitstream buffer 210. While the bitstream data resides in the input bitstream buffer 210 or as it is sent to the output bitstream buffer 220, it can be monitored by the start code monitor 230. If the start code monitor 230 detects a start code, it can send the location of the start code to the shift length limiter 240 and, in some embodiments, to the receiver 130.

In accordance with the invention, the bitstream data can be transferred from the input bitstream buffer 210 to the output bitstream buffer 220. The bitstream data resides in the output bitstream buffer 220 until the output bitstream buffer 220 receives a command to shift the data or enters the shift state. After the bitstream data in the output bitstream buffer 220 is shifted, the output bitstream buffer 220 can be refilled by the data from the input bitstream buffer 210.

The shift length limiter 240 can receive the location of the start code from the start code monitor 230 and the location of the current bit pointer from the output bitstream buffer 220. Using the current bitstream pointer and the address of the start code, the shift length limiter 240 can calculate the number of bits between the current pointer and the start code. This number can be used as a maximum number of bits the shift length limiter 240 will allow the output bitstream buffer 220 to shift out to the receiver 130.

When the shift length limiter 240 receives an instruction from the receiver 130, instructing the output bitstream buffer 220 to shift a certain number of bits N, the shift length limiter 240 can compare the number N with the maximum number of bits calculated as a function of the start code location and the current bit pointer. If the requested number of bits N is greater then the number of bits between the current pointer location and the start code, the shift length limiter 240 can inhibit the output bitstream from shifting the bits. Instead, the shift length limiter 240 can return a status message to the receiver 130, indicating an error in the bitstream or shifting request.

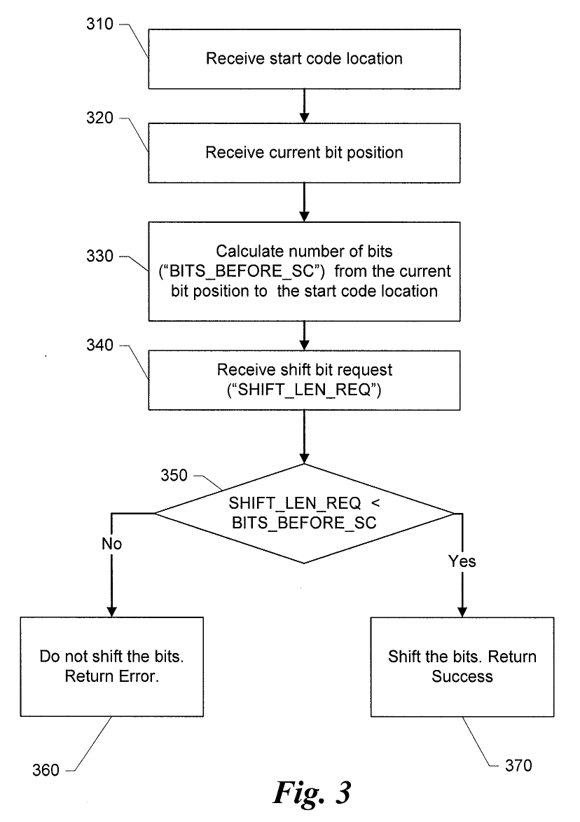

FIG. 3 illustrates one example of the flow control that can be used by the shift length limiter 240 to control the shifting in the output bitstream buffer 220. In step 310, the shift length limiter 240 can receive the start code location. The start code location can be received from the start code monitor 230.

In step 320, the shift length limiter 240 can receive the current bit position. The shift length limiter 240 can retrieve the current bit position from the output bitstream buffer 220. For example, the current bit position can be sent by the output bitstream buffer 220 to the shift length limiter 240 when the value of the current bit position is modified or when a request for data comes from the receiver 130.

In step 330, the shift length limiter 240 can use the current bit position and the position of the start code to determine the number of bits before the start code BITS_BEFORE_SC. In one embodiment of the present invention, BITS_BEFORE_SC can be determined by subtracting the address location of the start code from the address location of the current bit. For example, if the start code was found at the location 100 and the current bit pointer is at the location 200, the value of the BITS_BEFORE_SC will be 100. If the location of the start code is unknown, then the value of the BITS_BEFORE_SC can be the maximum number of bits stored in the output bitstream buffer 220 or the input bitstream buffer 210 or a combination thereof.

In one embodiment of the present invention, BITS_BEFORE_SC can be determined by the start code monitor 230 and simply forwarded to the shift length limiter 240. In that embodiment, the start code monitor 230 can determine the BITS_BEFORE_SC as a function of the location of the start code in the input bitstream buffer 210 and the location of the current pointer from the output bitstream buffer 220.

When the shift length limiter 240 receives the shift command from the receiver 130, the logic of the step 330 is executed. In one embodiment, the shift length limiter 240 can ensure that it has the current values of the bit pointer and of the start code. In step 350, the shift length limiter 240 compares the number of requested bits with the BITS_BEFORE_SC. If the number of requested bits is smaller then BITS_BEFORE_SC, the shifting is allowed. If the number of requested bits is larger then BITS_BEFORE_SC, the a shifter overrun error is returned. In some embodiments, if the number of requested bits is larger then BITS_BEFORE_SC, the shift length limiter 240 may also raise a hardware interrupt.

If the number of requested bits is larger then BITS_BEFORE_SC, no shifting is performed. In this case, the digital bitstream shifter according to the present invention, will return an error indication to the receiver 130.

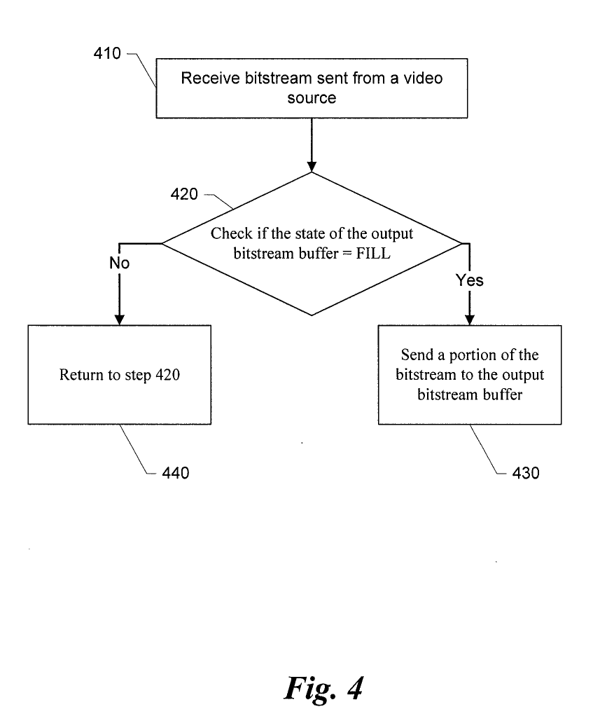

FIG. 4, with reference to FIG. 1 and FIG. 2, provides a flowchart illustrating one embodiment of the invention. In step 410, the input stream buffer 210 receives the bitstream sent from the sending device 110. The data can be received over the transmission medium 115. In step 420, the input bitstream buffer 210 checks the state of the output bitstream buffer 220. If the state of the output bitstream buffer 220 indicates that output bitstream buffer 220 can accept more data (FILL), in step 430 the received data can be transmitted to the output bitstream buffer 220. If the output bitstream buffer 220 is in the SHIFT state (it does not accept new data), the input bitstream buffer 210 can wait until the state changes from SHIFT to FILL. In an alternative embodiment, the output bitstream buffer 220 can be receiving data at the same time it is shifting out to the receiver 130. In this embodiment, the output bitstream buffer 220 can include separate ports for receiving and sending data and a circular buffer which can store data in unused locations as data is shifted out to the receiver 130.

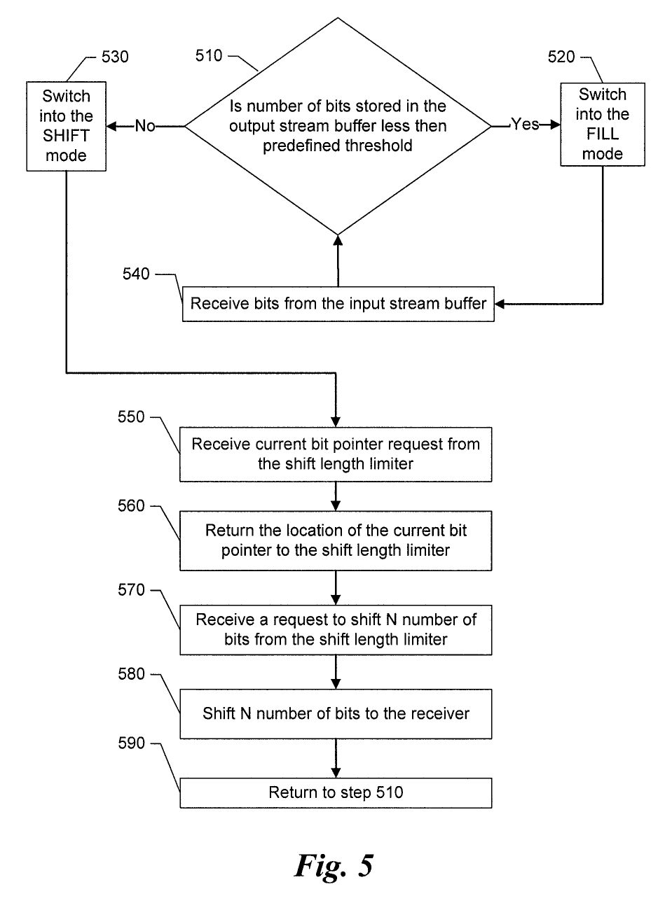

FIG. 5, with reference to FIG. 1 and FIG. 2, provides a flowchart illustrating one embodiment of the invention. In step 510, the output bitstream buffer 220 monitors the number of bits stored to determine if the number of bits is below a predefined threshold. If it is below the threshold, in step 520, the output bitstream buffer 220 switches into the FILL mode. The FILL mode can provide an indication to the input bitstream buffer 210 that the output bitstream buffer 220 can accept more data. In step 540, the output bitstream buffer 220 can receive bitstream data from the input stream buffer 210. When the amount of received data reaches the predefined threshold, the output bitstream buffer 220 in step 530 can switch into the SHIFT mode.

In step 550, the output bitstream buffer 220 can receive a request from the shift length limiter 240 for an indication of the current bit pointer position. The current bit pointer can indicate the location of the first bit that will be transmitted to the receiving device 130. In step 560, the output bitstream buffer can return the location of the current bit pointer to the requestor. In step 570, the output bitstream buffer 220 can receive a shift bit request to shift N number of bits. In one embodiment of the present invention, this request can come from the shift length limiter 240. In step 580, the output bitstream buffer 220 shifts the requested number of bits to the receiving device 130. Finally, in step 590, the flow is repeated starting from the step 510.

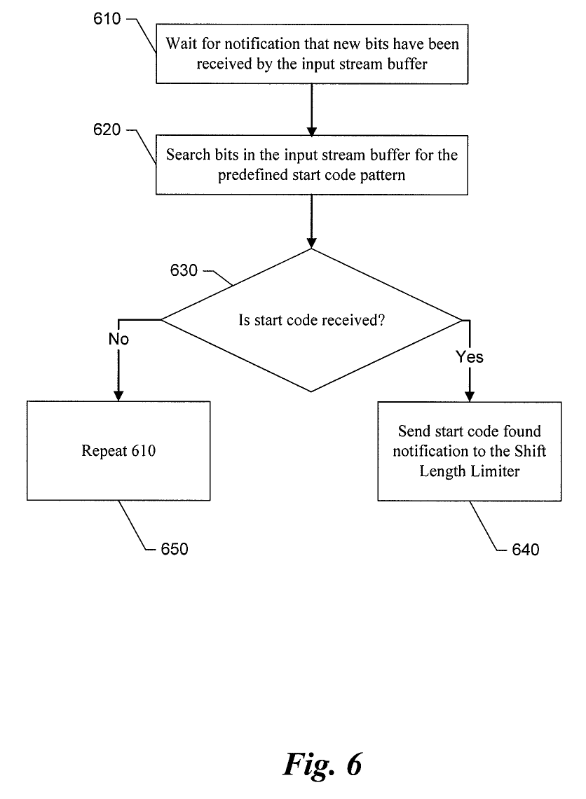

FIG. 6, with reference to FIG. 1 and FIG. 2, provides a flowchart illustrating one embodiment of the start code monitor 230 according to the present invention. In step 610, the start code monitor 230 waits for the notification that the new bits have been received by the input bitstream buffer 210. In some embodiments according to the present invention, the start code monitor 230 can periodically check the number of bits stored in the input bitstream buffer 210 to find out whether any new bits have been received.

In step 620, the start code monitor 230 can search the bits stored in the input stream buffer 210 for the pre-defined start code pattern. The search can be done using one or more search algorithms or devices known to one with ordinary skill in the art. For example, the search can be done using an N-bits wide comparator for parallel monitoring, or, using a 1-bit serial comparator in an N-states signature analyzer. In step 630, the start code monitor 230 can check whether the start code pattern has been identified. If so, in step 640, the start code monitor 230 can notify the shift length limiter 240 that a start code pattern has been identified. In some embodiments according to the present invention, the start code monitor 230 can also provide the bit location in the bitstream of the start code pattern to the shift length limiter 240. If the start code pattern was not identified, in step 650, the start code monitor 230 can repeat all of the steps described above, starting from the step 610.

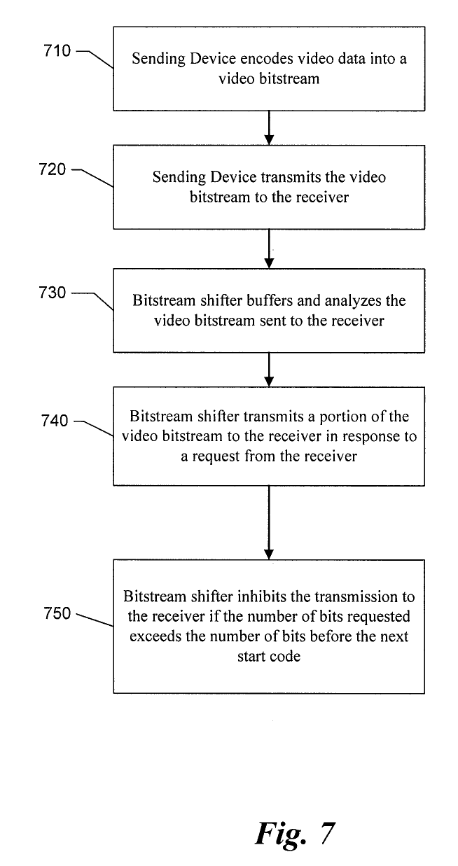

Finally, FIG. 7, with reference to FIG. 1 and FIG. 2, provides a flow chart illustrating logic of one embodiment of the digital bitstream shifter according to the present invention. In step 710, the sending device 110 can encode the video data into a bitstream using any of the video data compression algorithms described above. In step 720, the sending device 110 transmits the video bitstream to the receiver 130. In step 730, the bitstream shifter 120 buffers and analyzes the bitstream data for start code patterns before shifting out to the receiver 130. In step 740, the bitstream shifter 120 receives a request for N number of bits of bitstream data from the receiver 130. In response to the request, the bitstream shifter 20 can send the requested number of bits to the receiver 130. Finally, in step 750, the bitstream shifter 120 inhibits the transmission to the receiver 130 if the number of bits requested exceeds the number of bits before the next start code.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

The present invention can also be used with audio, image and general media digital signal transmission standards. For example, the present invention can be applied to audio compression standards that include MPEG-1 Layer III (known as MP3), MPEG-1 Layer II, AAC, HE-AAC, G.711, G.722, G.722.1, G.722.2, G.723, G.723.1, G.726, G.728, G.729, G.729a, WavPack, FLAC, iLBC, RealAudio, WMA, SHN, Speex, Musepack, Vorbis, ATRAC and AC3; image compression formats that include JPEG, JPEG 2000, JPEG-LS, JBIG, JBIG2, GIF, PNG, TIFF, PCX, TGA, BMP, WMP, ILBM; and, general media container formats that include AU, AIFF, WAV, NUT, MXF, Matroska, Ogg, Ogg Media, MP4, QuickTime, RealMedia, AVI, ASF, 3GP.

Further, while the description above refers to the invention, the description may include more than one invention.

What is claimed is:

1. A method of processing a bitstream having a start code pattern, the method comprising:
a) receiving a location of the start code pattern in the bitstream;
b) receiving a location of a current bit pointer in the bitstream;
c) determining a number of bits between the start code pattern location and the current bit pointer location;
d) receiving from a receiver, a first request for a number of bits from the bitstream; and
e) sending to the receiver the number of bits requested if the number of bits requested in said first request does not exceed the number of bits between the start code pattern location and the current bit pointer location.

2. The method of processing the bitstream of claim 1, wherein the bitstream is a video bitstream.

3. The method of processing the bitstream of claim 1, wherein the bitstream is an audio bitstream.

4. The method of processing the bitstream of claim 1, wherein the bitstream is a still image bitstream.

5. The method of claim 1 further comprising:
f) raising an interrupt if the number of bits requested exceeds the number of bits between the start code pattern location and the current bit pointer location.

6. The method of claim 1 further comprising:
f) receiving from the receiver, a second request for a number of bits from the bitstream; and
g) inhibiting the sending of the number of bits requested if the number of bits requested in said second request exceeds the number of bits between the start code pattern location and the current bit pointer location.

7. The method of claim 6, further comprising:
h) providing an indication of an error to the receiver.

8. A bitstream receiver comprising:
an input bitstream buffer connected to a bitstream source and adapted for buffering a first portion of a bitstream;
an output bitstream buffer connected to the input bitstream buffer and adapted for buffering a second portion of the bitstream;
a start code monitor for detecting a start code location in the first portion of the bitstream;
a shift length limiter for receiving a current bit pointer location from the output bitstream buffer and for determining a number of bits between the current bit pointer location and the start code location.

9. The bitstream receiver of claim 8, wherein the bitstream receiver is a video receiver.

10. The bitstream receiver of claim 8, wherein the bitstream receiver is an audio receiver.

11. The bitstream receiver of claim 8, wherein the bitstream receiver is a still image receiver.

12. The bitstream receiver of claim 8, wherein the output bitstream buffer can operate in a fill mode and in a shift mode.

13. The bitstream receiver of claim 12, wherein the output bitstream buffer automatically switches from the shift mode to the fill mode.

14. The bitstream receiver of claim 13, wherein the switching from the shift mode to the fill mode occurs when a number of bits stored in the output bitstream buffer falls below a predefined threshold.

15. The bitstream receiver of claim 8, wherein the shift length limiter receives a shifting request to shift a number of bits stored in the output bitstream buffer.

16. The bitstream receiver of claim 15, wherein the shift length limiter compares the number of bits between the current bit pointer location and the start code location with the number of bits in the shifting request.

17. The bitstream receiver of claim 16, wherein the shift length limiter raises an interrupt if the number of bits between the current bit pointer location and the start code location is smaller then the number of bits in the shifting request.

18. A bitstream processing device comprising:
a bitstream buffer adapted to be connected to a source of a bitstream, said bitstream buffer adapted to buffer a first portion of the bitstream and to send a second portion of the bitstream to a decoder;
a start code monitor connected to the bitstream buffer and adapted to detect one or more start code patterns in the first portion of the bitstream buffered in the bitstream buffer;
a shift length limiter coupled to the bitstream buffer and the start code monitor and adapted to determine a number of bits between a bit pointer of the bitstream buffer and a location of at least one of the detected start code patterns in the bitstream; and
wherein the bitstream buffer is adapted to receive, from the decoder, a request for a number of bits from a the first portion of the bitstream and wherein the bitstream buffer is inhibited from sending the second portion of the bitstream to the decoder if the number of bits requested is greater than the number of bits between a bit pointer of the bitstream buffer and a location of one or more detected start code patterns.

19. The bitstream processing device of claim 18, wherein the bitstream is video bitstream and the decoder is a video bitstream decoder.

20. The bitstream processing device of claim 18, wherein the bitstream is audio bitstream and the decoder is an audio bitstream decoder.

21. The bitstream processing device of claim 18, wherein the bitstream is still image bitstream and the decoder is a still image bitstream decoder.
